(19) United States
(12) Patent Application Publication
(10) Pub. No.: US 2022/0301063 A1
(43) Pub. Date: Sep. 22, 2022

(54) Data-Valuation Information Management System and Method

(71) Applicant: YourDataConnect, LLC, Old Tappan, NJ (US)

(72) Inventors: Sunil Edward Soares, Harrington Park, NJ (US); William Alexander Scroggins, III, Mt. Juliet, TN (US)

(73) Assignee: YourDataConnect, LLC, Old Tappan, NJ (US)

(21) Appl. No.: 17/722,419

(22) Filed: Apr. 18, 2022

Related U.S. Application Data
(63) Continuation-in-part of application No. 17/490,980, filed on Sep. 30, 2021.
(60) Provisional application No. 63/271,553, filed on Oct. 25, 2021.
(60) Provisional application No. 63/163,910, filed on Mar. 21, 2021.

(51) Int. Cl. G06Q 40/06

(52) U.S. Cl. CPC G06Q 40/06

(57) ABSTRACT

This invention supports creation and use of data-management-system metrics. Information relating to the value of an enterprise's data and the value of the enterprise may be collected from various publicly available networks for various enterprises. This information may used to determine the relative financial-impacts of the various enterprise data-management systems. For example, a data-monetization index (DMI) may consist of the ratio of the value of enterprise data to the value of the enterprise. An enterprise's DMI may be compared to other enterprise's DMI or industry-aggregate DMI to determine the relative data-management-system impacts. Data-management-system metrics from external enterprises may be compared with a subject enterprise's internally generated metrics to assess potential relative weaknesses in the subject enterprise's data-management system and to recommend work-flow or other actions to address those weaknesses.

### CROSS-REFERENCE TO RELATED APPLICATIONS

This application claims the benefit of U.S. Provisional Patent Application No. 63/271,553 filed on Oct. 25, 2021. This application is also a continuation-in-part of U.S. patent application Ser. No. 17/490,980 filed on Sep. 30, 2021 which claims the benefit of U.S. Provisional Patent Application No. 63/163,910 filed on Mar. 21, 2021.

### BACKGROUND

This invention pertains generally to information management systems. More specifically, the invention is directed to technology to improve operation of enterprise information systems by assigning data value and realizing data value.

Data management is essential to any enterprise. In recent history, many enterprises have focused their data-management efforts on regulatory compliance and mitigating risks from breach or loss of data. One drawback to such a focus is that determining return on investment into data management is difficult.

### SUMMARY

Systems according to aspects of the invention can provide an end-to-end process for data monetization including the creation of a data balance sheet, valuation of data, creation of a data risk registry, placing data on a data exchange, and realizing enterprise value from data.

In one aspect of the invention, an improved enterprise information system includes a processor (that may be, e.g., a centralized processor or a distributed processor), a data store (that may be, e.g., a centralized data store or a distributed data store), and a user interface configured to enable the user to select or enter a data-valuation model. The processor, data store, and user interface are interconnected and the processor is structured to: (1) receive a data-valuation model from the user interface, (2) retrieve enterprise data from one or more enterprise data stores according to this data-valuation model, (3) determine a data value for the retrieved data, and (4) associate the data value with the retrieved data. For example, the data-valuation model may be a parameterized business use case for the data that the user selects (e.g., from a menu of preconfigured models) or creates through combining preconfigured models, entry of new parameters and relationships, or some combination thereof. The parameterized data-valuation model may further include indicia of what parameter(s) are input business-case drivers or of what parameter(s) are output business-case drivers. The data may be retrieved from one or more enterprise data stores using data-valuation parameters to identify the data store(s). The data valuation may be based on, e.g., a discounted cash flow analysis for the use/management of the data, a comparables analysis with other data sets, a Monte Carlo simulation of the use/management of the data, or a Markov chain incorporating use/management of the data. The processor may be further structured to configure a data balance sheet by: (1) defining a chart of accounts for data, which chart includes divisions, sub-divisions, data accounts, and/or business use cases, (2) associating a data value for each business use case, and (3) rolling up the data value to each sub-division and division. For example, an enterprise may have fleet division, with fleet-specific data, and an automobile subdivision, with automobile-specific data. A business use case for use of automobile-location sensor data to optimize logistics or working capital may be accessed and used by the processor to value the sensor data. The value may be associated with the business use case and rolled up into a subdivision, division, or enterprise summary.

In another aspect of the invention, a method for improving operation of an enterprise information system includes receiving a data-valuation model, receiving enterprise data according to the data-valuation model, determining a value for the retrieved data, and associating that value with the enterprise data. Receiving the data-valuation model may include creating or selecting a data-valuation model based on a business use case for enterprise data. Receiving the enterprise data may include identifying one or more enterprise data stores using the data-valuation model. Valuing the enterprise data may be based on, e.g., a discounted cash flow analysis for the use/management of the data, a comparables analysis with other data sets, a Monte Carlo simulation of the use/management of the data, or Markov chain incorporating use/management of the data. A data risk registry may be managed in the enterprise information system by determining the inherent risk of an event, mapping this risk to enterprise data, identifying potential mitigants for the risk, determining a residual risk based on the mitigants, and displaying the inherent and residual risk in a 3D graphic (e.g., a heat map). A data exchange may be managed in the enterprise information system by identifying the enterprise data, managing the visibility of the data to various users and groups, and managing access requests to the data for various users and groups.

In another aspect of the invention, a data-management platform includes a processor (that may be, e.g., a centralized processor or a distributed processor), a network interface that can connect the processor to a network, and a user interface. The processor, network interface, and user interface are interconnected and the processor is structured to: (1) identify an enterprise (e.g., a publicly traded company), (2) search a publicly accessible network (e.g., the Internet) for information about the enterprise (e.g., share price, job postings, data-breach reports), (3) retrieve information about the enterprise from data stores on the network, (4) determine the value of a set of enterprise data (e.g., a subset of the enterprise's entire data or the entire data), and (5) determine a value of the enterprise (e.g., market capitalization or enterprise value). The processor may be further structured to determine a ratio of the value of the data set to the value of the enterprise. The user may, through the user interface, enter or edit a data-valuation model for valuing the data set. The processor may be further structured to select and use an industry-applicable data-valuation model. The processor may be further structured to identify a different enterprise, access data for that enterprise through a network of that enterprise, and determine the value of the data and the enterprise. The processor may be structured to compare the value of an enterprise or its data set with the value of a different enterprise or data set or (or with an aggregate, such as an industry average). This may be done, e.g., by comparing ratios of data value to enterprise value. The processor may be structured to generate a recommended course of action based on the comparison. For example, the processor may identify and provide potential data-management actions for an enterprise that differs from a benchmark competitor or aggregate to address the difference.

In another aspect of the invention, a method for operating a data-monetization platform includes identifying a number of enterprises, searching publicly accessible networks for information about the enterprises, retrieving information regarding the enterprises over the networks, determining values for data sets and enterprises for the identified enterprises, and determining for each enterprise a data-monetization-index (DMI) consisting of the ratio of the data-set value to the enterprise value. The method may further include collecting information regarding a particular enterprise from data internal to that enterprise, valuing that data and enterprise, and comparing the DMI for that enterprise with that for the other enterprises (individually or in aggregate). A recommended data-management action may be generated based on the comparison(s).

The invention expands the capabilities and improves the operation of prior-art enterprise information systems in a number of ways. For example, it enables a system that goes beyond data access, retention, and collection and includes assessment of data value in various contexts.

### BRIEF DESCRIPTION OF THE DRAWINGS

These and other features, aspects, and advantages of the present invention will become better understood with reference to the following description, appended claims, and accompanying drawings where:

FIG. 1 is a functional block diagram illustrating an exemplary data-management system according to an aspect of the invention.

FIG. 2 is a functional block diagram of an exemplary data-valuation system according to an aspect of the invention.

FIG. 3 is a system diagram illustrating an exemplary networked system for managing enterprise information including an exemplary data-management system according to an aspect of the invention.

FIG. 4 is an exemplary data-balance-sheet-creation process-flow algorithm according to an aspect of the invention.

FIG. 5 is an exemplary data-valuation process-flow algorithm according to an aspect of the invention.

FIG. 6 is an exemplary data-risk-registry-management process-flow algorithm according to an aspect of the invention.

FIG. 7 is an exemplary data-exchange-management process-flow algorithm according to an aspect of the invention.

FIG. 8 is an exemplary process-flow algorithm to realize enterprise value according to an aspect of the invention.

FIG. 9 is an exemplary data risk registry dashboard according to an aspect of the invention.

FIG. 10 is a plot of exemplary loss exceedance curves showing the value of data in a risk-reduction application according to an aspect of the invention.

FIG. 11 is a functional block diagram illustrating an exemplary data-monetization platform according to an aspect of the invention.

FIG. 12 is a functional block diagram illustrating exemplary recommendation and realization engines of an exemplary data-monetization system according to an aspect of the invention.

FIG. 13 is a functional block diagram illustrating an exemplary data-valuation portal.

FIG. 14 is a functional block diagram illustrating an exemplary data-monetization platform.

### DETAILED DESCRIPTION

In the summary above, and in the description below, reference is made to particular features of the invention in the context of exemplary embodiments of the invention. The features are described in the context of the exemplary embodiments to facilitate understanding. But the invention is not limited to the exemplary embodiments. And the features are not limited to the embodiments by which they are described. The invention provides a number of inventive features which can be combined in many ways, and the invention can be embodied in a wide variety of contexts. Unless expressly set forth as an essential feature of the invention, a feature of a particular embodiment should not be read into the claims unless expressly recited in a claim.

Except as explicitly defined otherwise, the words and phrases used herein, including terms used in the claims, carry the same meaning they carry to one of ordinary skill in the art as ordinarily used in the art.

Because one of ordinary skill in the art may best understand the structure of the invention by the function of various structural features of the invention, certain structural features may be explained or claimed with reference to the function of a feature. Unless used in the context of describing or claiming a particular inventive function (e.g., a process), reference to the function of a structural feature refers to the capability of the structural feature, not to an instance of use of the invention.

Except for claims that include language introducing a function with “means for” or “step for,” the claims are not recited in so-called means-plus-function or step-plus-function format governed by 35 U.S.C. § 112(f). Claims that include the “means for [function]” language but also recite the structure for performing the function are not means-plus-function claims governed by § 112(f). Claims that include the “step for [function]” language but also recite an act for performing the function are not step-plus-function claims governed by § 112(f).

Except as otherwise stated herein or as is otherwise clear from context, the inventive methods comprising or consisting of more than one step may be carried out without concern for the order of the steps.

The terms “comprising,” “comprises,” “including,” “includes,” “having,” “haves,” and their grammatical equivalents are used herein to mean that other components or steps are optionally present. For example, an article comprising A, B, and C includes an article having only A, B, and C as well as articles having A, B, C, and other components. And a method comprising the steps A, B, and C includes methods having only the steps A, B, and C as well as methods having the steps A, B, C, and other steps.

Terms of degree, such as “substantially,” “about,” and “roughly” are used herein to denote features that satisfy their technological purpose equivalently to a feature that is “exact.” For example, a component A is “substantially” perpendicular to a second component B if A and B are at an angle such as to equivalently satisfy the technological purpose of A being perpendicular to B.

Except as otherwise stated herein, or as is otherwise clear from context, the term “or” is used herein in its inclusive sense. For example, “A or B” means “A or B, or both A and B.”

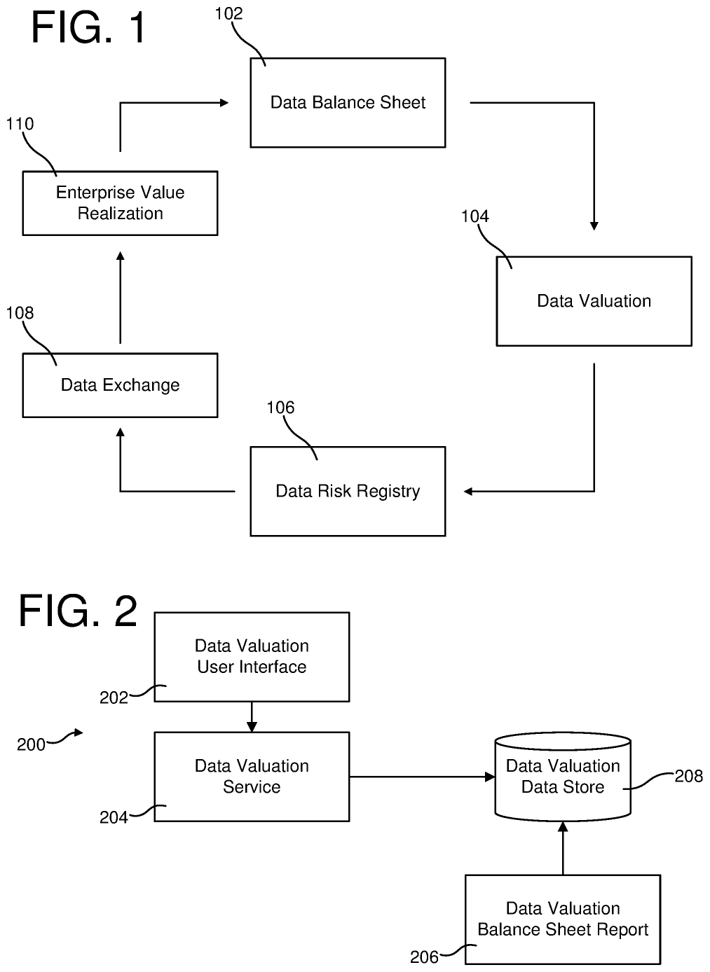

The exemplary system depicted in FIG. 1 includes five modules: a data-balance-sheet module 102, a data-valuation module 104, a data-risk-registry module 106, a data-exchange module 108, and an enterprise-value-realization module 110. The modules may be implemented in any combination or individually. And the modules may be implemented in a distributed or centralized computer system.

The data-balance-sheet module 102 provides tools for creating and viewing balance sheets including data accounts and associated data assets and liabilities. For example, a balance sheet may include a CUSTOMER data account which may include data assets/liabilities such as customer data, accounts receivables, and collateral. The data assets/liabilities within the account may be associated with business use cases relating to growing revenues, reducing costs, managing risk, or improving cash flows, which in turn may be associated with a value. For example, the cost of managing a particular data account may be represented as a long-term debt having a net present value based on a discount rate and service duration. Imagine yearly fixed data-management costs of $170M for the next three years and an associated discount rate of 5%. This can be represented as long-term debt with a net present value of about $463M (with discount rate applied beginning in the first year). The aggregation of data assets and liabilities in the data balance sheet enables one to quantify the impact of data on enterprise value. In particular, the difference between data asset values and data liability values indicates an equity value due to the data. In this way, data is accounted for in a data balance sheet in a manner similar to accounting for more traditional assets and liabilities in a traditional GAAP or IFRS balance sheet. As with the traditional balance sheet, the (data) accounting equation (equity=assets-liabilities) may indicate an error condition, such as negative equity, which is flagged for resolution/investigation. For example, if data assets are greater than data liabilities, then the enterprise is presumed to be data solvent. On the other hand, if data liabilities are more than data assets, then the enterprise is presumed to be data bankrupt.

The data-valuation module 104 provides tools for valuing a particular data asset/liability. This may be implemented in a data-valuation system, as described below.

The data-risk-registry module 106 provides tools for quantifying risk in or due to data and categorizing data accounts based on that risk. Tools for quantifying risk include Monte Carlo simulations and Markov Models.

The data-exchange module 108 provides tools for selective and controlled sharing data amongst stake holders and users. For example, a particular data account, or a data set(s) within an account, may be made available to a certain individuals or classes of users but hidden or protected from access outside that group. The module 108 may aggregate diverse data accounts to ease access to the data by providing a single interface to the accounts.

FIG. 2 depicts an exemplary data-valuation system 200. The data valuation system 200 includes a user interface 202, a data-valuation service 204, a data store 208, and a balance-sheet-report service 206. The user interface 202 includes tools for user manipulation of data-valuation models. For example, the user may select or create a business use case for valuing the data. For this data-valuation approach, the data is valued based on its impact in a particular business use. For instance, an enterprise attempting to reduce its working capital by reducing inventory, and thereby increase its free cash flow, will collect and analyze data indicating the amount of inventory on hand and that needed. This can enable the enterprise to better manage its inventory and thereby reduce its carrying costs. A portion of this benefit can be attributed to the data and compared to the associated costs to determine the return on investment in the data (including its collection, maintenance, organization, and analysis). Similarly, a prospective valuation of this data, based on expected benefits and costs, can be used to determine whether the data investment is warranted. Other exemplary business-use-case valuations include valuing data used to reduce shipping costs, ensure adherence to contractual terms, reduce barriers to customer consumption, and optimize financial-capital reserves. Common to each use case is that the data valuation may be used to determine the viability of the data-management project (prospectively or in hindsight).

The data-valuation service 204 calculates the value of data using a sum of business cases or using Artificial Intelligence techniques such as Monte Carlo Simulations or Markov Models.

The data store 208 provides a repository for data-valuation models and valuation methodologies of particular data sets. Models that are established by the user via the data valuation user interface 202 may be saved here. For example, a user may create a new model through input or selection of a business case for a data set to be valued. This new model may be persisted in the data store 208 for later access, such as to update the valuation of the data set or to configure the model for a different data set. In another example, a user may select and configure a preexisting model for a specific data set or for a different type of data. This configuration may be persisted in the data store 208 for later use.

The balance-sheet-report service 206 will access previously valued data accounts or sets in the system and summarize the value of the data individually or in the aggregate.

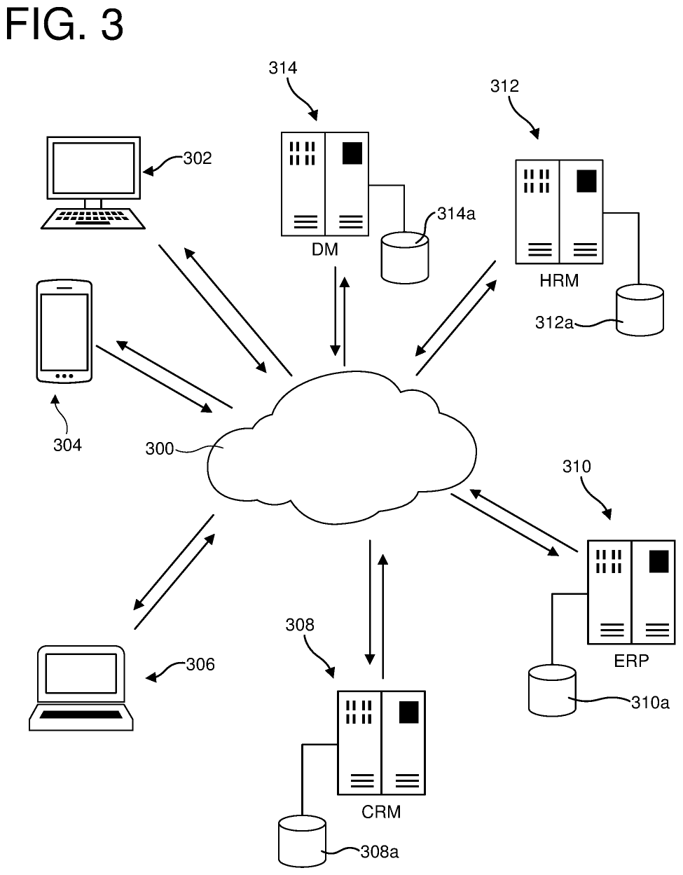

FIG. 3 depicts an exemplary networked enterprise information system (EIS). The system includes various user devices 302, 304, 306, a customer-relationship-management (CRM) subsystem 308 having an associated data store 308a, an enterprise-resource-planning (ERP) subsystem 310 having an associated data store 310a, a human-resource-management (HRM) subsystem 312 having an associated data store 312a, and a data-management (DM) subsystem 314 having an associated data store, 314a. The DM subsystem 314 can collect data from the various other subsystems in the EIS in order to, e.g., assess the value and risk in enterprise data, track enterprise data in a balance sheet, and list enterprise data in a user-accessible exchange.

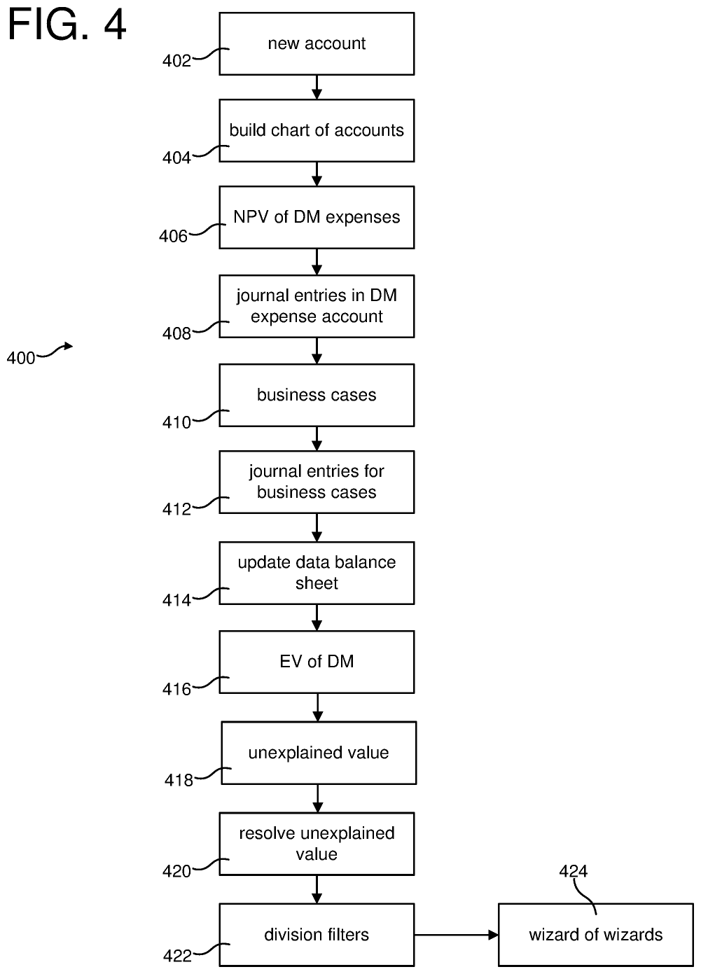

FIG. 4 depicts an exemplary flow 400 to create a data balance sheet. The system creates a new account on the data balance sheet 402, builds a chart of accounts for data assets 404, calculates net present value of data management expense as a proxy for long-term debt 406, creates journal entries in the data management expense account 408, creates business cases 410, creates journal entries to roll up business cases to the data balance sheet 412, adjusts the value of accounts on the data balance sheet using journal entries 414, quantifies the enterprise value of data management as a proxy for shareholders' equity 416, places the unexplained value on the data balance sheet representing the difference between data assets and data liabilities 418, assigns owners to resolve unexplained value so that the value of data assets is equal to or greater than data liabilities 420, creates division filters on the data balance sheet 422, and sets up the wizard of wizards to automate data balance sheet inputs 424. The wizard of wizards 424 comprises entry of a ticker symbol, automated ingestion of financial details, provision of inputs to create business cases, and automatic generation of business cases.

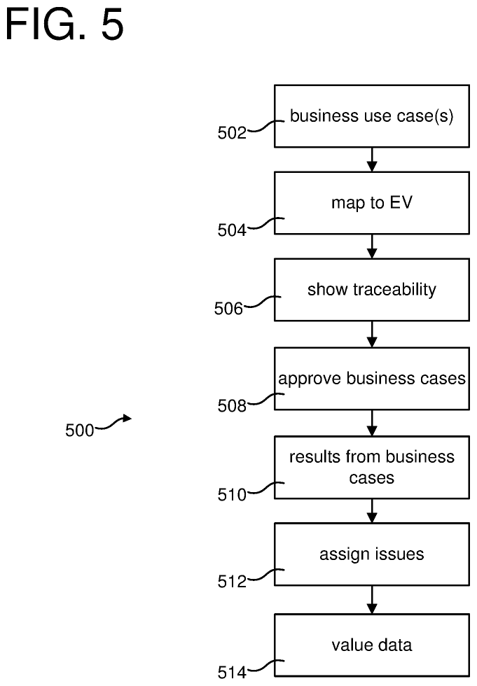

FIG. 5 depicts an exemplary flow 500 to value data. The system includes selecting one or more business use cases 502. A business case may be directed to improving cash flows, reducing costs, growing revenues, or reducing risks. Business cases involving risk reduction may involve the manual use of business cases, valuation and reduction of cybersecurity risk using Monte Carlo Simulations, or valuation and reduction of regulatory risk using Monte Carlo Simulations. The business case(s) are mapped to an enterprise value 504. The enterprise value is the sum of equity market value and long-term debt minus cash on hand. The system shows traceability of business cases to input variables and business terms in a graphical manner using a knowledge graph 506. Business cases are reviewed for approval 508, results from business cases are returned 510, and issues are assigned to data owners 512. Data is valued 514 using a sum of business cases or an aggregate basis. The system supports the aggregate value of business cases using comparables or using data science, which in turn is based on Monte Carlo simulations or Markov chains.

For example, a business use case (BC) may be used to calculate the financial benefits of data quality for ship-to addresses at a medical device manufacturer. This case may involve: (1) a number of ship-to-addresses in the customer master database (A); (2) an estimate of the percentage of inaccurate customer ship-to-addresses (B); (3) the estimated number of inaccurate ship-to-customer addresses (C=A×B); (4) the average delay in weeks where the product is not installed at the customer site due to inaccurate ship-to-address (D); and (5) the average sales of aftermarket consumables per customer per week (E). The business benefits of increased data quality regarding the ship-to-address (F) may be estimated as F=C×D×E. For example, if there are 100,000 addresses in the database and 2% of these addresses are incorrect, there are 2,000 incorrect addresses (C=A×B=100,000×2%). If the average delay in installing equipment due to incorrect addresses is 4 weeks and the average weekly sales of consumables for installed equipment is $500, the business benefit of accurate address information is $4,000,000 (F=C×D×E=2,000×4× 500).

A business case may be used to value data on an aggregate basis. For example, one may estimate the value of data from a wearable fitness application (e.g., a data-collection application for an exercise watch) on a per-user basis (A) and the number of app users (B) to estimate the value of the data set (C=A×B). For a value of $2/user and 1,000,000 users the value of the data set is $2,000,000 (C=2×1,000,000).

Monte Carlo simulations may be used to model uncertain future revenues and costs in a business use case. For instance, some or all of the projected revenues and costs associated with a business use case may be associated with a probability distribution. For example, the cash flow (FLOW) associated with a future revenue or cost for a particular time period may be expected to take on any of a variety of different values (flow) according to different probabilities (Pi). In a Monte Carlo simulation, a series of alternative business-use-case valuations may be created by repeatedly selecting cash-flow values according to their probability distributions (e.g., a probability mass function or a probability density function). This yields a probability distribution of business-case valuations, and associated distribution metrics such as range, expected value, and variance. The cash flows may be decomposed into multiple parameters, each having an associated probability distribution that is utilized by the Monte Carlo simulation. For example, a shipping cost may equal the number of units shipped multiplied by the per-unit shipping price. Projections for the number of units shipped may be based on a uniform probability distribution between a maximum and minimum number of units (which may vary from time period to time period). Projections for the price per unit may be based on a normal probability distribution defined by a standard deviation and a mean. In this instance, the Monte Carlo simulation would utilize both probability distributions to select alternate cost values. Examples around clinical trial data valuation and ransomware risk reduction are presented in this submission using Monte Carlo simulations.

The value of data may be determined in a Monte Carlo simulation by, e.g., simulating how the data may impact cash-flow drivers. In a similar manner, the value of risk, and of using data to reduce risk, may be simulated by assigning a probability distribution to the value of a risk event (considering both the probability of the risk manifesting and the cost the ripened risk would impose), projecting how that probability/value may be reduced using data, and projecting the cost of utilizing data to reduce the risk.

One example of the use of Monte Carlo simulation to value data would be to value a clinical trial in the context of developing a pharmaceutical oncology drug. The drivers for the valuation of the clinical trial data include: (1) the cost of a Phase III Oncology Clinical Trial (A); (2) the probability of success of the Phase III Oncology Clinical Trial (B); (3) the annual revenues for oncology drug for 10 years (C); (4) the gross margin percent for oncology drugs (D); (5) the gross margin percentage for 10 years (E=C×D/100); and (6) the net present value (F) of the gross margin over 10 years at a discount rate (r), where

$$F = {\sum }_{i = 1}^{10} \frac{E}{{( 1 + r )}^{i}} . \qquad ( 1 )$$

Each driver is assigned minimum and maximum values based on evidence. The system then generates minimum, average and maximum values for the clinical trial data over a configured number of simulations such as 10,000 or higher. Revenues and gross margins from sales of the drug may be projected based on probability distributions for yearly sales and gross margin percentage and a probability of trial success. The discounted present value of the yearly gross margins less the cost of the projected cost of the trial (which may have an associated probability distribution) represents the value of the trial. For example, for an oncology drug having an expected clinical-trial cost falling in the range of $11.5M to $52.9M, a probability of trial success in the range of 0 to 72%, annual revenues in the range of $100M to $8.180B, and gross margin in the range of 68 to 83%, assuming uniform probability distributions for each parameter, a Monte Carlo simulation of 10,000 events might suggest the value of the clinical trial falls in the range of about −$10M to $37B, with an expectation value of about $18.9B. (The “M” and B suffixes here denote millions and billions respectively.)

Another example of using a Monte Carlo simulation to value data would be to value the data management efforts undertaken to mitigate the risk of the ransomware attack. This risk may be modelled using the probability of a successful ransomware attack (A, which may be represented as a probability distribution of probabilities), the cost of a successful ransomware attack (B, which may be represented as a probability distribution of costs), the cost of the downtime caused by a successful ransomware attack (C which may be represented as a probability distribution of costs). The expected total cost of a ransomware attack (D) is then given by: D=A×(B+C). The probability distribution of D may be determined through Monte Carlo simulation of multiple such events. The value of mitigation efforts may be modeled using the unmitigated risk (D, the modeled probability distribution), the cost of anti-ransomware mitigants (E, which may be represented as a probability distribution of costs), the probability of a successful ransomware attack after mitigation (F, which may be represented as a probability distribution of probabilities), and the cost of the downtime caused by a successful post-mitigation ransomware attack (G which may be represented as a probability distribution of costs). The expected total cost of a ransomware attack with mitigation efforts (H) is then given by: H=F×(B+G)+E. The probability distribution of H may be determined through Monte Carlo simulation of multiple such events. The mitigated and unmitigated expected total costs may be compared to determine the value of the mitigation efforts. For example, the distributions D and H may be compared using loss exceedance curves as depicted in FIG. 10. In this example, the tail risk at 10% probability declines from $100 million to about $50 million due to the mitigation, indicating a data-management value of $50 million.

Markov chains may also be used to value data. For example, the projected Customer Lifetime Value (CLV) of a customer is related to the projected periodic contribution margin from the customer and the probability of retaining the customer over the targeted time horizon. This can be modeled in a Markov chain where the contribution margin for each period (M) is the contribution margin from the previous period (Mᵢ₋₁) weighted by the probability of retaining the customer for that period (1— CHURN):

Mᵢ=Mᵢ₋₁×(1—CHURN);i≥2 (2).

(Here, CHURN denotes the customer churn rate, also known as the rate of customer attrition.) For example, the CLV of a health insurance customer is calculated over 36 months. The margin equals the monthly premiums paid by the customer less monthly claims paid by the insurance provider. The margin in Month 1 (M₁) is calculated as Margin minus Cost to Serve (CTS) minus Cost to Retain (CTR) minus Bad Debt multiplied by premium all divided by 12:

$${M}_{1} = \frac{( premium - claims ) - C T S - C T R - ( Bad Debt \times premium )}{12} . \qquad ( 3 )$$

The CLV is then given by:

$$C L V = {\sum }_{i = 1}^{36} \frac{{M}_{i}}{{( 1 + r )}^{i}} . \qquad ( 4 )$$

Where “r” is the monthly discount rate (e.g., a yearly discount rate of 5% divided by 12).

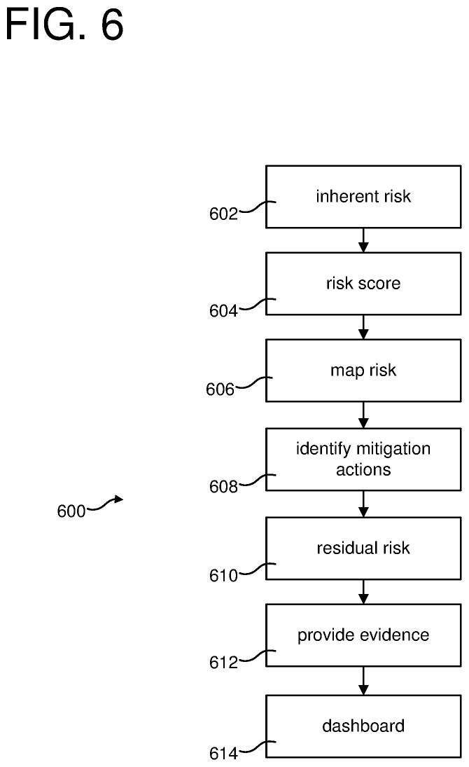

FIG. 6 depicts an exemplary flow to manage a risk registry dashboard (e.g., by creating or updating the dashboard). The system supports the calculation of inherent risk before any mitigation actions 602, calculation of risk scores 604, mapping data risks to data policies and regulations 606, identification of actions to mitigate risks 608, calculation of residual risk after mitigation actions 610, provision of evidence for the risk calculations 612, and creation of a data risk registry dashboard 614. The inherent risk represents the amount of risk in the absence of controls and may be determined as the probability of the risk event multiplied by the value of the event. The risk score may be determined as follows:

Risk Score=(probability+velocity)×(severity+1) (5).

Where “probability” is the probability of the risk event, “velocity” represents the speed of onset of the risk event, and “severity” reflects the impact of the risk event. Mapping of the risk entails associating the risk with a policy or regulation governing the at-risk data. Different data-management actions may be identified to reduce this risk. The residual risk is the amount of risk that remains after mitigation controls are accounted for. The data risk registry dashboard is a 3D graphic that shows probability, severity, and velocity of data risk.

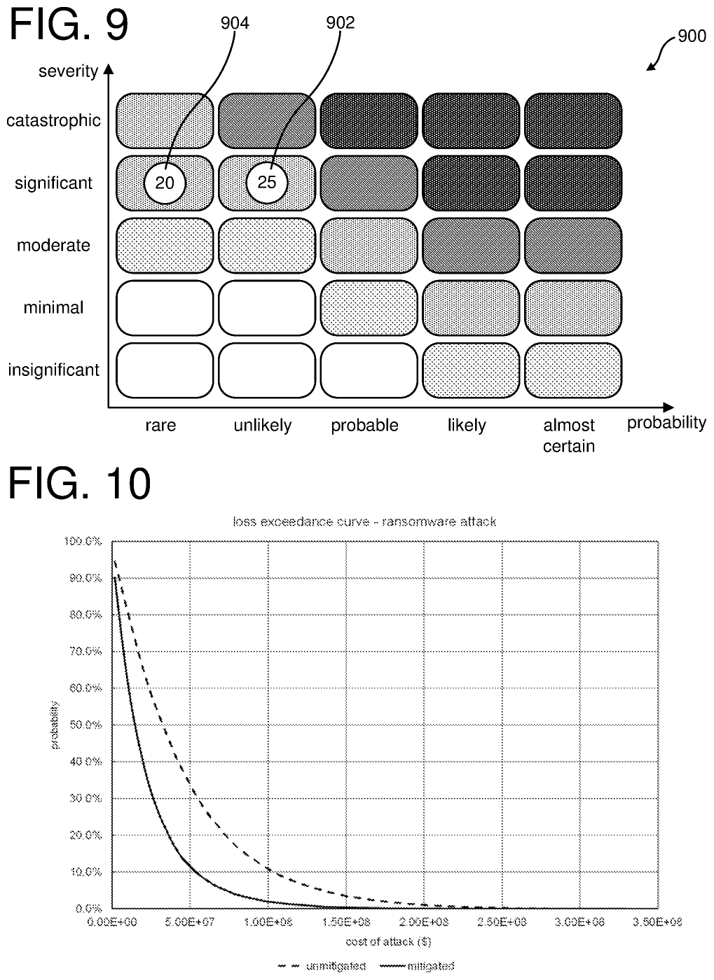

An exemplary data risk registry dashboard is depicted in FIG. 9. This example represents the risk of governmental fines for a data breach. Severity is along the vertical axis, here defined as taking on the ordinal values of “insignificant,” “minimal,” “moderate,” “significant,” and “catastrophic” which may be assigned the numerical values 1 through 5 respectively. Probability is along the horizontal axis, here defined as taking on the ordinal values of “rare,” “unlikely,” “probable,” “likely,” and “almost certain” which may be assigned the numerical values 1 through 5 respectively. And velocity is represented by shading, with darker shades corresponding to higher velocity and where the shades may be assigned numerical values 1 through 5 in order of increasing darkness. Other numerical values may be used for the risk score or dashboard. For example, probability may be represented on a scale of 0 to 1 (0 to 100%), severity may be represented as a dollar amount, and velocity may be represented in units of time. An exemplary risk score 902 for the inherent risk of an event is placed on the dashboard. Here, the risk score 902 represents an unlikely event (given the value of 2) with significant consequences (give the value of 4) with a medium velocity (give the value of 3): Risk Score=(2+3)×(4+1)=25. An exemplary risk score 904 for the residual risk is also placed on the dashboard. Here, the risk score 904 represents that mitigation efforts to protect against data breach will make the event less likely (rare, in this case, given the value of 1) than the unmitigated risk. This reduces the risk score: Risk Score=(1+3)×(4+1)=20. The evidence for the risk assessment in this instance may be past fines levied by the government for data breaches.

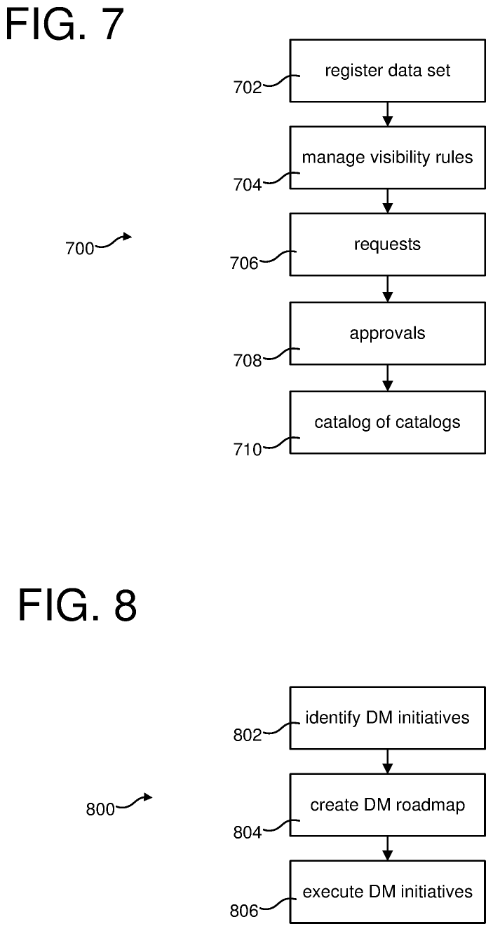

FIG. 7 depicts an exemplary flow for managing a data exchange (e.g., by creating or updating the exchange). The system includes the registration of a data set 702, managing rules of visibility of data sets 704, workflows to request data sets 706, workflows to approve data requests 708, and the creation of a catalog of catalogs 710. Registration involves identifying the data set in the exchange. Rules for when, where, and to whom data within the data is visible are set. These rules may differ from data set to data set and may vary over time. Workflows for data set owners to register the data set, users to request access to data sets, and for data exchange brokers to process such requests are established and managed in the exchange. Data sets that are scattered across various catalogs are accessible to users through a searchable catalog of catalogs.

FIG. 8 depicts an exemplary flow for realizing enterprise value from data. Enterprise value is the sum of equity market value and long-term debt minus cash on hand. The system includes the identification of data management initiatives 802, creation of a data management roadmap 804 and execution of data management initiatives 806. A data management initiative is an initiative to realize or assess the value of particular data. The roadmap is the sequence of steps to execute the initiative.

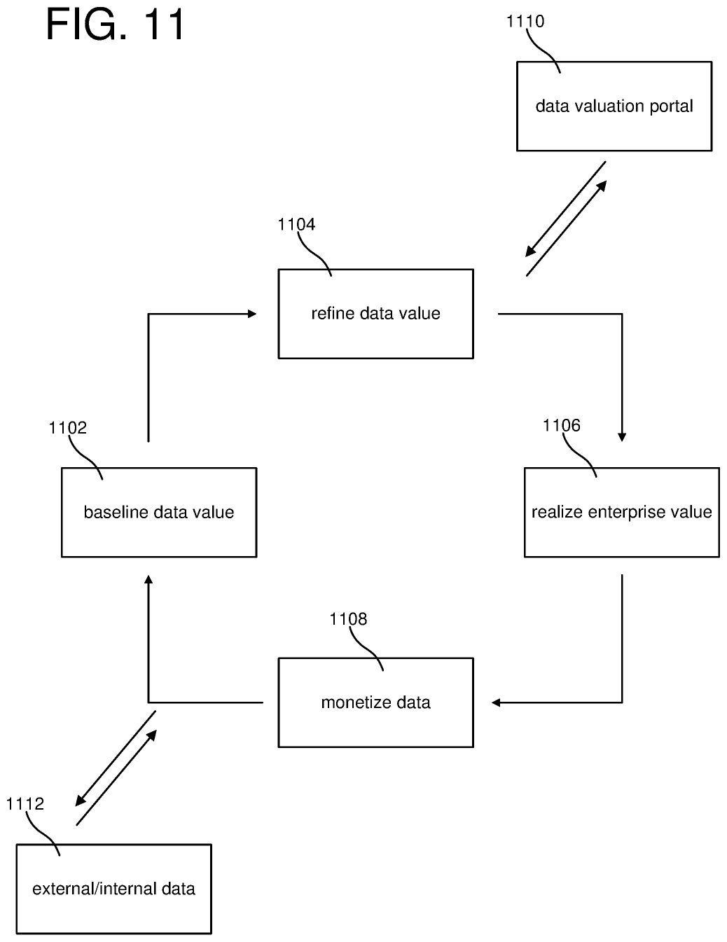

FIG. 11 depicts an exemplary data-monetization platform. The platform includes a baseline-data-value module 1102, a refine-data-value module 1104, a realize-enterprise-value module 1106, a monetize-data module 1108, a data-valuation portal 1110, and one or more data stores 1112. The baseline-data-value module 1102 utilizes external data sources 1112 and industry benchmarks to provide a baseline valuation for a data set. The refine-data-value module 1104 refines the baseline data valuation using internal data sources 1112 and valuation models. The external data sources 1112 are publicly accessible sources external to the enterprise. This may include open websites, government data, social media and may also include subscription services. For example, the external data 1112 may include information about an enterprise available on social-media jobsites (e.g., current job postings, estimates of salary ranges); information submitted to the SEC by an enterprise; information about an enterprise on a stock exchange; information about an enterprise from financial analysts; information about an enterprise released by an enterprise through, e.g., press releases, analyst meetings, shareholder meetings. The internal data sources 1112 are enterprise data sources not accessible to the public. The platform may generate one or more business recommendations based on the data valuation. For example, information may be collected from external data sources to determine various external-enterprise enterprise-data valuations and those data valuations may be compared with a valuation of data of a subject enterprise from data sources that are internal to the subject enterprise. The comparison of external-enterprise data values to subject-enterprise data values may identify how the subject-enterprise data-monetization efforts differ from the data-monetization efforts of external enterprises or from industry data-monetization practices. This comparison can be used to recommend to the subject enterprise data-management practices to improve its financial or competitive position vis-a-vis external enterprises or the industry.

The realize-enterprise-value module 1106 uses the refined valuation to realize the value of the data set by creating a data balance sheet and instigating operations based on a data-value-based data-management recommendation. The monetize-data module 1108 connects to a marketplace of curated buyers, facilitating monetization of the data set through sale or license of the data set. The data-valuation portal 1110 represents an enterprise's or individual's portal to the data-monetization platform. The data-monetization platform may be implemented, e.g., locally to the enterprise, as a PAAS (platform as a service), SAAS (software as a service), or as a Web application that users may connect to their internal data stores.

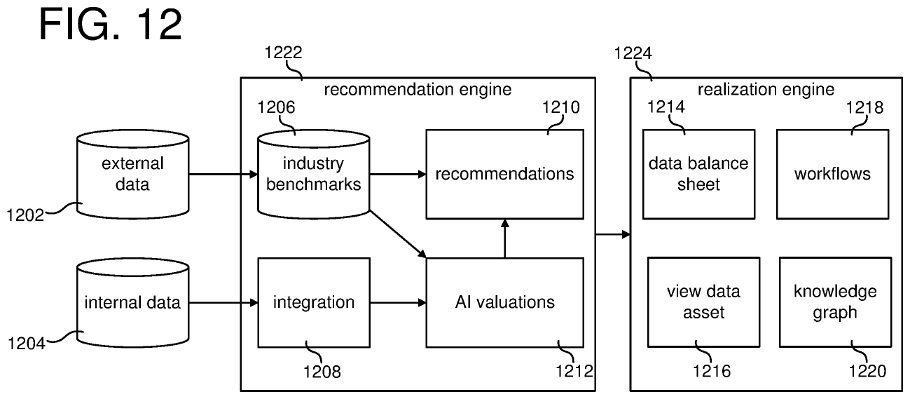

FIG. 12 is a functional block diagram illustrating exemplary connections of external and internal data stores 1202, 1204, a recommendation engine 1222, and a realization engine 1224. The recommendation engine 1222 provides a baseline data valuation by applying industry benchmarks 1206 using data external to the enterprise 1202. For example, a data set (e.g., enterprise customer data) may be valued using valuations of analogous data in comparable enterprises (e.g., customer data for enterprises of a similar size/scope in the same or similar industry). The recommendation engine 1222 may identify valuable data internal to the enterprise 1204 and use such internal data to generate a data valuation or refine the benchmark-based valuation using, e.g., an integration module 1208 and artificial-intelligence techniques 1212. The valuation(s) are used to generate a recommendation 1210. For example, the system may determine that a particular enterprise under or over invests in data management (e.g., cybersecurity) relative to comparable enterprises and recommend modifying the investment toward the industry average. In another example, the system may determine the enterprise has a higher customer churn rate than comparable enterprises and recommend investing in customer retention policies. Information from the recommendation engine 1222 is used by the realization engine 1224 to operationalize the data set by, e.g., generating or updating: a data balance sheet 1214, a single view of the data asset 1216, a workflow 1218, or a knowledge graph 1220.

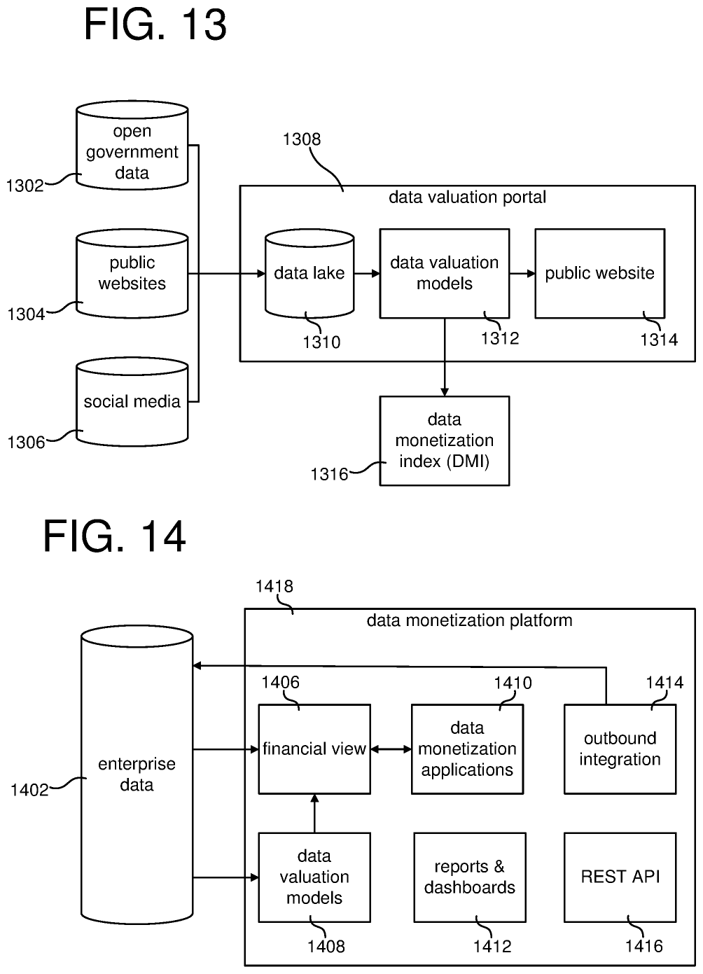

FIG. 13 is a functional block diagram illustrating an exemplary data-valuation portal. The portal 1308 is connectable to a variety of external data stores, such as open government data 1302 (e.g., SEC Edgar), public websites 1304, and social media 1306. The portal 1308 includes a data lake 1310, data valuation models 1312, and a public website 1314. The portal 1308 collects data from the external data stores 1302, 1304, 1306 into the data lake 1310. Data from the data lake 1310 may be subject to one or more data valuation models 1312 to generate a data value. The portal 1308 may produce a measure of an enterprise's data's monetization efficiency or efficacy, the “data monetization index” or “DMI” 1316. This index may be, e.g., the ratio of an enterprise's data value to its total value. For example, a DMI for an enterprise may be defined as:

$$DMI = \frac{data value}{market capilalization} \qquad ( 6 )$$

$$or$$

$$DMI = \frac{data value}{enterprise value} \qquad ( 7 )$$

The DMI may be used in a variety of applications. For example, it can be used to benchmark by comparing an enterprise's DMI to another DMI, such as that of an industry or sector standard, aggregate, exemplar, or leader. In another example, the DMI may be used to inform data-based financing (e.g., as a collateral or equity valuation tool). The public website 1314 of the portal serves as an interface. The data valuation platform 1308 may serve as a data valuation research center by, e.g., providing data valuations for various companies, industries, sectors, and market indices. It may also provide research articles, notes, blogs and the like through its website.

FIG. 14 is a functional block diagram illustrating an exemplary data monetization platform. The platform 1418 is connectable to enterprise data stores. Data may be valued using data valuation models 1408 and a financial view of the data may be generated 1406. The platform 1418 may include data monetization applications 1410 (e.g., a data exchange) and an outbound integration 1414 to enterprise data (or other components of the enterprise information system). The data monetization platform 1418 may provide reports and dashboards 1412, data valuations for the enterprise, financial views in the form of data balance sheets, data risk registries, and a data exchange for direct monetization through, e.g., sale or licensing of enterprise data.

While the foregoing description is directed to the preferred embodiments of the invention, other and further embodiments of the invention will be apparent to those skilled in the art and may be made without departing from the basic scope of the invention. And features described with reference to one embodiment may be combined with other embodiments, even if not explicitly stated above, without departing from the scope of the invention. The scope of the invention is defined by the claims which follow.

The invention claimed is:

1. A data-management platform comprising:
(a) a processor of the group consisting of a centralized processor and a distributed processor;
(b) a network interface configured to connect the processor to one or more networks; and
(c) a user interface;
(d) wherein the processor is configured to perform an algorithm comprising:
(i) identifying a first enterprise;
(ii) searching a publicly accessible network for information about the first enterprise;
(iii) retrieving, from one or more data stores on the publicly accessible network, information about the first enterprise;
(iv) determining a value of a set of data of the first enterprise; and
(v) determining a value of the first enterprise.

2. The data-management platform of claim 1 wherein the processor algorithm includes a step of determining a ratio of the data-set value to the first-enterprise value.

3. The data-management platform of claim 1 wherein the set of data for which the value is determined is the aggregate of all data assets of the first enterprise and the value of the first enterprise is one of the group consisting of a market capitalization of the first enterprise and an enterprise value of the first enterprise.

4. The data-management platform of claim 1 wherein the step of determining a value of a set of data is performed using a data-valuation model selected by a user.

5. The data-management platform of claim 1 wherein:
(a) the processor algorithm includes the step of identifying an industry in which the enterprise for which the enterprise information was retrieved operates; and
(b) the step of determining a value of a set of data is performed using a data-valuation model based on the industry.

6. The data-management platform of claim 1 wherein the processor algorithm further includes:
(a) identifying a second enterprise;
(b) retrieving, from one or more data stores on a second-enterprise network, second-enterprise data;
(c) determining a value of the retrieved second-enterprise data; and
(d) determining a value of the second enterprise.

7. The data-management platform of claim 6 wherein the processor algorithm includes:
(a) comparing the second-enterprise-data value with the first-enterprise-data value; and
(b) generating a recommendation for management of the second-enterprise data based on the comparison of the second-enterprise-data value with the first-enterprise-data.

8. The data-management platform of claim 6 wherein the processor algorithm includes:
(a) comparing the second-enterprise-data value with an aggregate of two or more valuations of other enterprise's data; and
(b) generating a recommendation for management of the second-enterprise data based on the comparison of the second-enterprise-data value with the other-enterprise-data value.

9. The data-management platform of claim 7 wherein the processor algorithm includes generating a ratio of first-enterprise-data value to first-enterprise value and the comparing of the second-enterprise-data value to the first-enterprise-data value includes a comparison of the ratio of second-enterprise-data value to second-enterprise value to the ratio of first-enterprise-data value to first-enterprise value.

10. The data-management platform of claim 8 wherein the processor algorithm includes generating, for the other enterprises, an aggregate of the ratios of other-enterprise-data value to other-enterprise value and the comparing of second-enterprise-data value to the aggregate of other-enterprise-data values includes a comparison of the ratio of first-enterprise-data value to first-enterprise value to the aggregate of ratios of other-enterprise-data value to other-enterprise value.

11. A method for operating a data-monetization platform, the method comprising:
(a) identifying one or more external enterprises;
(b) searching a publicly accessible network for information about the external enterprises;
(c) retrieving, from one or more data stores on the publicly accessible network, information about the external enterprises;
(d) for each external enterprise, determining the value of a set of data of the external enterprise based on the retrieved external-enterprise information;
(e) for each external enterprise, determining the value of the external enterprise based on the retrieved external-enterprise information;
(f) for each external enterprise, determining a data-monetization-index consisting of the ratio of the value of the set of data of the external enterprise to the value of the external enterprise.

12. The method of claim 11 further comprising:
(a) retrieving, from one or more data stores on a subject-enterprise network, subject-enterprise data;
(b) determining a value of the retrieved subject-enterprise data;
(c) determining a data-monetization-index consisting of the ratio of the value of the retrieved subject-enterprise data to the value the subject enterprise;
(d) comparing the subject-enterprise data-monetization-index to at least one external-enterprise data-monetization-index;
(e) generating a recommendation for management of the subject-enterprise data based on the comparison subject-enterprise data-monetization-index to at least one external-enterprise data-monetization-index.
